(19) United States
(12) Patent Application Publication
(10) Pub. No.: US 2025/0342664 A1
(43) Pub. Date: Nov. 6, 2025

(54) IMAGE PROCESSING METHOD, ELECTRONIC DEVICE AND READABLE STORAGE MEDIUM

(71) Applicant: Beijing Zitiao Network Technology Co., Ltd., Beijing (CN)

(72) Inventors: Yunlong FU, Beijing (CN); Xi LI, Beijing (CN)

(21) Appl. No.: 18/868,682

(22) PCT Filed: Aug. 17, 2023
(86) PCT No.: PCT/CN2023/113504

§ 371 Date: Nov. 22, 2024

(30) Foreign Application Priority Data
Aug. 17, 2022 (CN) 202210989469.7

(51) Int. Cl. G06T 19/00; G06F 3/01; G06F 3/04815

(52) U.S. Cl. CPC G06T 19/006; G06F 3/04815; G06F 3/017

(57) ABSTRACT

The present disclosure provides an image processing method, an electronic device and a readable storage medium. The method includes: obtaining identification information by identifying an identification pattern in a media image; obtaining virtual information corresponding to media content displayed in the media image according to the identification information; obtaining an image acquired in real time; and obtaining a three-dimensional image based on the virtual information and the image acquired in real time.

The present application claims the priority of the Chinese Patent Application No. 202210989469.7 filed on Aug. 17, 2022, and the content disclosed in the Chinese Patent Application is hereby incorporated by reference in its entirety as part of the present application.

### TECHNICAL FIELD

The present disclosure relates to a method and an image processing apparatus.

### BACKGROUND

Generally, electronic devices have the function of playing multimedia content, which allows users to watch a variety of videos, images, and the like through the electronic devices, and to interact with the multimedia content by actions such as giving it a thumbs-up, sharing the content, adding it to favorites, or the like. Augmented Reality (AR) can integrate virtual information with real-world information to achieve the effect of augmented reality. It is one of the hot technologies that has attracted attention at present. It has become a hot topic to combine the AR technology with the multimedia content to better meet the diverse needs of users in the process of watching the multimedia content.

### SUMMARY

In order to solve the above technical problems, the present disclosure provides an image processing method and an apparatus.

In first aspect, an embodiment of the present disclosure an image processing method, comprising:
obtaining identification information by identifying an identification pattern in a multimedia image;
obtaining virtual information corresponding to multimedia content displayed in the multimedia image according to the identification information;
obtaining an image acquired in real time; and
fusing the virtual information with the image acquired in real time to obtain a three-dimensional image.

In some embodiments, the method further comprises: displaying the three-dimensional image.

In some embodiments, the method is applied to a first terminal, and the obtaining identification information by identifying an identification pattern in a multimedia image comprises:
obtaining the identification information corresponding to the multimedia image by identifying a QR code pattern or a barcode pattern in the multimedia image displayed by the first terminal to a second terminal.

In some embodiments, a transparency of the identification pattern is lower than a preset threshold.

In some embodiments, the obtaining virtual information corresponding to multimedia content displayed in the multimedia image according to the identification information comprises:
sending the identification information to a service terminal, so that the service terminal determines the virtual information according to the identification information; and receiving the virtual information sent by the service terminal.

In some embodiments, the three-dimensional image comprises an image of a target virtual object, and the method further comprises: in response to an adjustment operation for the target virtual object, updating the three-dimensional image.

In some embodiments, the three-dimensional image comprises an image of a target virtual object, and the method further comprises: in response to a triggering operation for the target virtual object, displaying association information of the target virtual object.

In second aspect, an embodiment of the present disclosure provides an image processing apparatus, comprising:
an identifying module, configured to obtain identification information by identifying an identification pattern in a multimedia image;
a virtual information obtaining module, configured to obtain virtual information corresponding to multimedia content displayed in the multimedia image according to the identification information;
an image acquisition module, configured to obtain an image acquired in real time; and
a fusing module, configured to fuse the virtual information with the image acquired in real time to obtain a three-dimensional image.

In second aspect, an embodiment of the present disclosure provides an electronic device, comprising: a memory and a processor, wherein,
the memory is configured to store a computer program instruction; and
the processor is configured to execute the computer program instruction to enable the electronic device to implement the image processing method in the first aspect or in any item of the first aspect.

In fourth aspect, an embodiment of the present disclosure provides readable storage medium, comprising: a computer program instruction, wherein, the computer program instruction, when executed by an electronic device, enables the electronic device to implement the image processing method in the first aspect or in any item of the first aspect.

In fifth aspect, an embodiment of the present disclosure provides a computer program product, which, when executed by an electronic device, enables the electronic device to implement the image processing method in the first aspect or in any item of the first aspect.

### BRIEF DESCRIPTION OF DRAWINGS

The drawings herein are incorporated into the description and form a part of the specification. They show the embodiments conforming to the present disclosure and are used together with the description to explain the principles of the present disclosure.

In order to illustrate the embodiments of the present disclosure more clearly, the drawings that need to be used in the embodiments are briefly described below. It is obvious that for those skilled in the art, other drawings may be obtained from these drawings without creative labor.

FIG. 1 is a schematic diagram of an application scenario for an image processing method provided in an embodiment of the present disclosure;

FIG. 2 is a flow chart of an image processing method provided in an embodiment of the present disclosure;

FIG. 3A is a flow chart of an image processing method provided in another embodiment of the present disclosure;

FIG. 3B is a flow chart of an image processing method provided in another embodiment of the present disclosure;

FIG. 4A to FIG. 4D provide schematic diagrams of a scenario and an interactive interface provided in an embodiment of the present disclosure;

FIG. 5A to FIG. 5D provide schematic diagrams of a scenario and an interactive interface provided in an embodiment of the present disclosure;

FIG. 6A to FIG. 6B provide schematic diagrams of a scenario and an interactive interface provided in an embodiment of the present disclosure;

FIG. 7A to FIG. 7C provide schematic diagrams of a scenario and an interactive interface provided in an embodiment of the present disclosure;

FIG. 8 is a structural schematic diagram of an image processing apparatus provided in an embodiment of the present disclosure; and

FIG. 9 is a structural schematic diagram of an electronic device provided in an embodiment of the present disclosure.

### DETAILED DESCRIPTION

In order to better understand the purpose, features, and advantages of the present disclosure, the solution of the present disclosure is further described below. It should be noted that, without conflict, the embodiments of the present disclosure and the features in the embodiments may be combined with each other.

Many of the specific details are set out in the following description to fully understand the present disclosure, but the present disclosure may also be implemented in other ways different from those described herein. Obviously, the embodiments herein are only some embodiments of the present disclosure, instead of all embodiments of the present disclosure.

AR technology is a technology that integrates virtual information with the real environment. It simulates the virtual information and superimposes it into the real environment, so that a virtual object and the real environment can exist in a same image and space, thereby “enhancing” the real environment. In this process, it can be perceived by senses of users, so as to enhance the user experience.

The embodiments of the present disclosure provide a method and an apparatus for image processing, and the method includes: obtaining identification information corresponding to an identification pattern by identifying the identification pattern in a multimedia image that is being displayed; obtaining virtual information corresponding to multimedia content displayed in the multimedia image according to the identification information; acquiring images in a real environment and real time, and fusing the virtual information and the images acquired in real time to obtain a three-dimensional image. The method of the present disclosure combines the AR technology with the multimedia content, enabling a user to obtain the virtual information related to the multimedia content by identifying the identification pattern in the multimedia image when watching the multimedia content, and the user can obtain extended content associated with the multimedia content through the virtual information, which enhances the interaction between the user and the multimedia content and meets the diverse needs of the user when watching the multimedia content, improving the user experience.

The image processing method provided by the present disclosure combines the AR technology with video technology to enable the user to obtain the virtual information that matches the multimedia image by scanning the multimedia image when watching the multimedia content, and fuses the virtual information with the real environment to obtain a three-dimensional image. The three-dimensional image shows the extended content associated with the multimedia content displayed in the multimedia image to the user. The user can obtain the extended content associated with the multimedia content through the virtual information, which enhances the interaction between the user and the multimedia content and meets the diverse needs of the user when watching the multimedia content. In addition, the three-dimensional image is more stereoscopic, and gives the user a unique perception, which greatly improves the user experience. The multimedia content can be, but is not limited to, videos, images, and the like.

In the method of the present disclosure, the terminal that displays the multimedia content and the terminal that performs the image processing method may be the same terminal, which is not limited in the present disclosure.

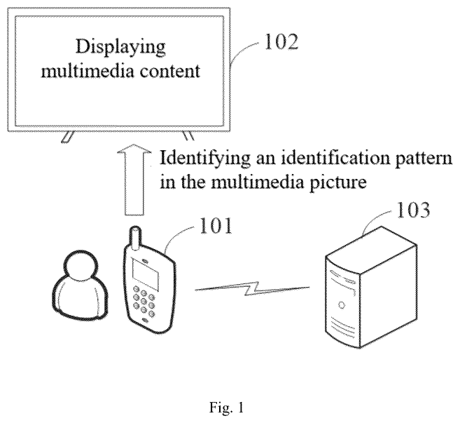

FIG. 1 is a schematic diagram of an application scenario for an image processing method provided in an embodiment of the present disclosure. As shown in FIG. 1. the scenario includes: a first terminal 101 and a second terminal 102.

In some embodiments. the image processing method of the present disclosure is performed by the first terminal 101, and the second terminal 102 is configured to display a multimedia content.

The first terminal 101 may use the AR technology to display a three-dimensional image with an enhanced effect for a user, and the three-dimensional image includes images of one or more virtual objects, and these virtual objects are related to multimedia content displayed in a multimedia image of the second terminal 102. The first terminal 101 may be any type of an electronic device, for example, a mobile phone, a pad, a laptop computer, a smart wearable device, AR glasses, an AR helmet, and the like. The first terminal 101 may also be referred to as an AR device, an augmentation device, and the like.

The first terminal 101 obtains virtual information locally or from a server by identifying the identification pattern in the multimedia image displayed by the second terminal 102, and then fuses the virtual information with the image of the real environment acquired in real time to obtain a three-dimensional image with enhanced effect. The virtual information includes information of one or more virtual objects associated with the video content. The virtual object may include, but is not limited to, computer-generated text, an image, a 3D model, a music, a video, and the like. The 3D model may be a 3D model corresponding to any type of an object, such as an animal, a plant, a household item, a house building, a vehicle, a planet, a card, a three-dimensional graphic, a special effect animation, and the like.

In some embodiments, a service terminal 103 stores virtual information; the first terminal 101 interacts with the service terminal 103 through WiFi, 3G/4G/5G or other wireless networks, and obtain the corresponding virtual information from the service terminal 103.

The virtual information stored in the service terminal 103 may be created in advance by a video publisher or a video publishing platform based on the multimedia content, and then published or stored to the service terminal 103. It may be understood that there is a corresponding relationship between the virtual information stored in the service terminal 103 and the multimedia content.

The second terminal 102 is an electronic device with a display function capable of playing multimedia content with an identification pattern. The second terminal 102 may include, but is not limited to, electronic devices such as a smart phone, a television, a projection device, a mobile terminal or other intelligent devices. In some embodiments, the second terminal 102 may, but is not limited to, play the multimedia content through an installed video application (that is, a video app), and the second terminal 102 may obtain data of the multimedia content from the service terminal corresponding to the video application and play it. The second terminal 102 may also be referred to as a display device, a video playback device, and the like.

In other embodiments. the terminal that plays the multimedia content may be the same terminal as that performs the image processing method. For example, they may be executed by the first terminal 101 in the embodiment shown in FIG. 1. The first terminal 101 identifies the identification pattern in the multimedia image that is displayed by itself and obtains virtual information locally or from the service terminal, and then the first terminal 101 fuses the virtual information with the image of the environment acquired in real time to generate a three-dimensional image and display it for the user.

The image processing method provided in the present disclosure is described in detail below through several specific embodiments with reference to the accompanying drawings. In the following embodiment, the first terminal executing an image processing method is taken as an example.

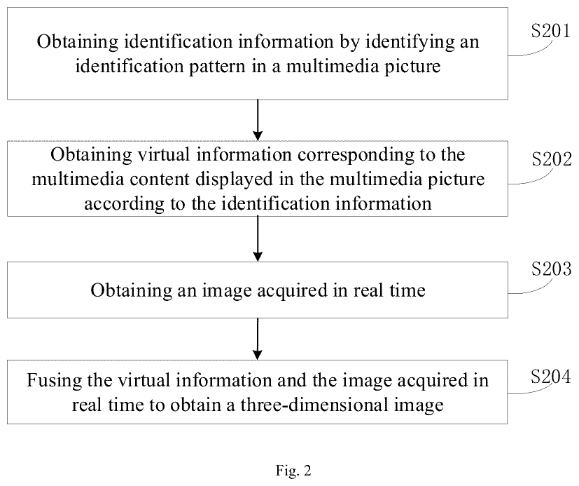

FIG. 2 is a flow chart of an image processing method provided in an embodiment of the present disclosure. As shown in FIG. 2, the method in the present embodiment includes:
S201: obtaining identification information by identifying an identification pattern in a multimedia image.

In the present embodiment, the multimedia content being a video is taken as an example, and the implementation mode is similar when multimedia content is an image. When the multimedia content is a video, the multimedia image may be understood as a video picture.

In some embodiments, the video is played on the second terminal, a specified application is installed in the first terminal. After the specified application is started, a user may control the camera of the first terminal to scan and identify the video picture displayed by the second terminal through the specified application, the user may make the camera point to the display screen of the second terminal, the camera may automatically scan the identification pattern in the video picture and decode the identification pattern to obtain the identification information.

In some embodiments, the first terminal plays a video, and the user may identify the identification pattern in the video picture through a trigger operation to obtain the identification information. For example, the user presses and holds the screen of the first terminal for a preset time period, or the user may trigger the identification of the identification pattern by operating a control provided on the screen of the first terminal.

The present disclosure does not limit to the following: the time period of the video currently being displayed on the first terminal or second terminal, the subject of the video content, the resolution of the video, full-screen playback or non-full-screen playback, and the current playback status (paused playback or playback state), and the like.

In the present disclosure, there is a corresponding relationship between the identification pattern in the video picture and the virtual information, and the virtual information that matches the video content in the video picture may be determined based on the information in the identification pattern. In some embodiments, the virtual information itself or the identification information corresponding to the virtual information may be encoded in advance to generate an identification pattern, and the identification pattern is added to all video frame images of the related video or in the video frame images of some video segments, so that the identification pattern can not only indicate the corresponding relationship between the virtual information that the user wants to obtain and the video, but also be used as a portal displayed for the user to obtain the virtual information. It should be noted that the implementation methods of encoding the identification information corresponding to the virtual information and decoding the identification pattern are not limited in the present disclosure, and they may be implemented through some existing encoding and decoding technologies.

The identification information may be the information corresponding to the identification pattern, the identification pattern is the identification pattern corresponding to the virtual information, and the identification information is the identification information corresponding to the virtual information and is used to obtain the corresponding virtual information. The identification information may include: the name and storage location of a data packet corresponding to the virtual information, and relevant descriptive information of the virtual information. The descriptive information may include, for example, the number of virtual objects included, information of a scenario corresponding to the virtual information, and the like.

The identification pattern may be, but not limited to, a barcode pattern, a QR code pattern, a text patterns, or the like. The position of the identification pattern in the video frame image and the display parameters (such as transparency, brightness, color, and the like) may be arbitrarily set, which is not limited in the present disclosure.

For example, the transparency of the identification pattern is lower than a preset threshold, and the identification pattern is provided as much as possible to near an edge position of the video picture, so as to ensure that the identification pattern does not block the video picture as much as possible, reduce the influence of the identification pattern on the video frame image, and allow the user to obtain the corresponding virtual information by identifying the identification pattern through the first terminal when watching the video, without affecting the viewing of the video content by the user, thereby improving the user experience. It should be noted that the identification pattern may be located on the lower layer of the video frame image: by setting the transparency of the identification pattern to be lower than the preset threshold and after superimposing the identification pattern and the video frame image, the user can clearly see the video frame image on the upper layer, and the identification pattern on the lower layer is in a close-to-hiding state, thereby reducing the block of the identification pattern to the video frame image. It should be understood that the preset threshold may be set as needed. In addition, because the user may not be able to accurately identify the position of the identification pattern through eyes, the first terminal may display a prompt for the user to prompt the user to identify the identification pattern, increasing the interest of the interaction.

For another example, the identification pattern may also be provided on the upper layer of the video frame image, and the identification pattern is displayed in a more obvious way, which allows the user to clearly determine the position of the identification pattern for identification when watching the video.

In some embodiments, identification patterns corresponding to different virtual information may be added to different video segments of one video. For example, the video A includes a video segment 1 explaining the universe and a video segment 2 explaining the ocean; the video segment 1 includes 100 video frame images, and the video segment 2 includes 150 video frame images. Therefore, identification patterns corresponding to the universe-based virtual information may be added to the 100 video frame images included in the video segment 1, and identification patterns corresponding to the ocean-based virtual information may be added to the 150 video frame images included in video segment 2. In other embodiments, the same identification pattern may also be added to all video frame images of the video. Furthermore, identification patterns corresponding to the virtual information to be added and the position of the video frame image corresponding to the identification pattern in the entire video may be determined based on the video content.
S202: obtaining the virtual information corresponding to the multimedia content displayed in the multimedia image, according to the identification information.

The virtual information corresponding to the multimedia content displayed in the multimedia image may include information of one or more virtual objects associated with the multimedia content, and the virtual objects may include, but are not limited to, computer-generated text, an image, a three-dimensional model, a music, a video, and the like, as described above.

In a possible implementation method, the first terminal has corresponding virtual information stored locally in advance, and the first terminal may query based on the identification information in the local storage space to obtain the virtual information that matches the identification information.

In another possible implementation method, the first terminal sends the scanned identification information to the service terminal that stores the virtual information, and the service terminal matches it in the database after receiving the identification information, obtains the virtual information that matches the identification information, and delivers the virtual information to the first terminal.

The above two methods can be used separately or in combination. For example, it may be queried on the first terminal locally, and in response to that no matched virtual information is found, interaction may be performed with the service terminal to obtain the virtual information from the service terminal.

In other embodiments, the identification pattern in the video picture itself is encoded based on the virtual information, and the AR device can directly obtain the virtual information by scanning the identification pattern for analysis, without interacting with the service terminal and without querying locally, making it simple and fast.

It should be noted that the first terminal may also obtain the virtual information in other ways, which are not limited in the present disclosure.
S203: Obtaining an image acquired in real time.
S204: Fusing the virtual information with the image acquired in real time to obtain a three-dimensional image.

The first terminal acquires an image of the real environment in real time through a camera, fuses the virtual information with the image of the real environment acquired in real time to obtain a three-dimensional image, and displays the three-dimensional image.

After identifying the identification pattern, the first terminal begins to acquire the real environment in real time to obtain the image of the real environment. The first terminal uses a plane detection technology to analyze the image of the real environment, determine a reference plane, and determine display parameters (such as display position, display size, display direction and so on) of each virtual object included in the virtual information based on the determined reference plane. After that, the first terminal superimposes the virtual objects on the image of the real environment acquired in real time based on the display parameters of each virtual object determined. and generates a three-dimensional image. After that, the resulting 3D image may be rendered and displayed.

It should be noted that the first terminal may acquire the real environment in real time through the camera with a preset time period. Therefore, the first terminal also needs to continuously carry out real-time calculation based on the image of the real environment acquired in real time, adjust the display parameters of the virtual objects, and superimpose and fuse the virtual objects with the image of real environment, thereby updating the three-dimensional image in real time.

In some embodiments, after the first terminal obtains the virtual information, or, before obtaining the virtual information and the first terminal scans to obtain the identification information corresponding to the virtual information, the first terminal may display an interactive interface to the user, display a pop-up window to the user in the interactive interface. The pop-up window may include a shooting button; in response to a trigger operation for the shooting button by the user, the first terminal begins to acquire the real environment through the camera and carry out the superposition and fusion between the images of the virtual information and the real environment.

The method according to the present embodiment combines the AR technology with the multimedia content, enabling a user to obtain the virtual information related to the multimedia content by identifying the identification pattern in the multimedia image when watching the multimedia content, and the user can obtain extended content associated with the multimedia content through the virtual information, which enhances the interaction between the user and the multimedia content and meets the diverse needs of the user when watching the multimedia content. In addition, the three-dimensional image is more stereoscopic, giving the user unique perception and greatly improving the user experience.

The first terminal generates a three-dimensional image and displays the three-dimensional image for the user through the first terminal, and the user may also interact with the image of the virtual object in the three-dimensional image, making it more interesting, and allowing for high interaction enthusiasm of users. The user interacts with the image of the virtual object in the 3D image by adjusting the display parameters of the virtual object, which includes one or more of the display position, display size, and display orientation. Alternatively, it can trigger the display of information associated with the virtual object being operated, such as a text message, video message, a link to a web page, and the like.

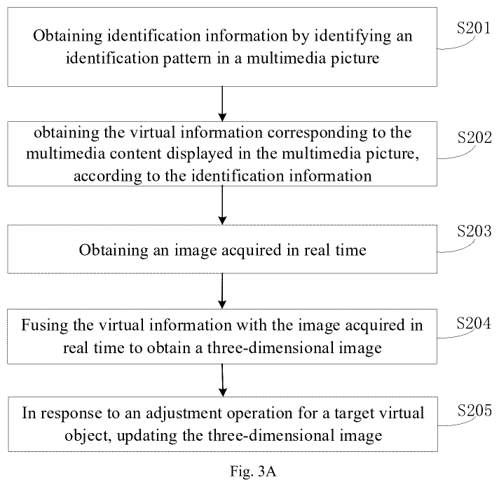

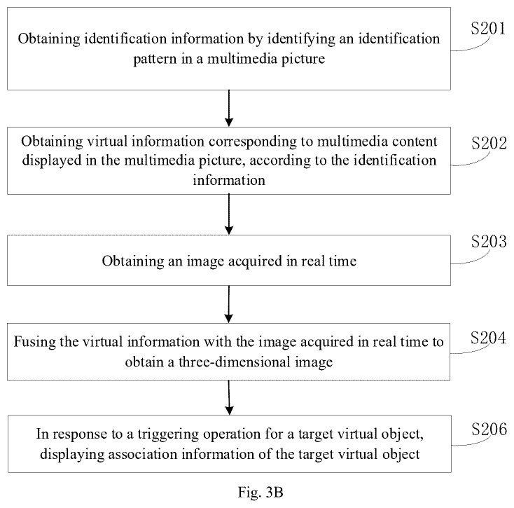

FIG. 3A is a flow chart of an image processing method provided in another embodiment of the present disclosure. As shown in FIG. 3A, based on the embodiment shown in FIG. 2, the method of the present embodiment, after S204, further includes:
S205: in response to an adjustment operation for a target virtual object, updating the three-dimensional image.

The three-dimensional image displayed by the first terminal is generated by fusing the acquired one or more virtual objects and the image acquired in real time. The three-dimensional image may include the image of all or part of the virtual objects, the target virtual object may be any one of a plurality of virtual objects displayed in the three-dimensional image, and therefore may also be understood as an image containing the target virtual object in the three-dimensional image.

The method for triggering the adjustment operation is not limited in the present disclosure. Exemplarily, the adjustment operation may be an action of a target part (such as a hand) acquired by the first terminal through the camera, or it may be an operation of the user on the image of the target virtual object in the display screen of the first terminal.

When the adjustment operation is triggered based on the action on the target part, for example, the first terminal is a mobile phone, the information of the real environment is acquired through the rear camera of the mobile phone for generating a three-dimensional image, the image of the target part is acquired through the front camera of the mobile phone, the action on the target part is determined through the posture of the target part, the action track, the action time, the action speed, and the like.

After detecting the action on the target part. the specific adjustment method corresponding to the adjustment operation may be determined based on the action on the target part, and the adjusted display parameters corresponding to the target virtual object may be obtained. The display parameters of other virtual objects may be also obtained, and the adjusted display parameters corresponding to the target virtual object and the display parameters of other virtual objects are superimposed and fused with the image of the real environment acquired by the camera in real time to generate the updated three-dimensional image, and the updated three-dimensional image is displayed for the user. The user can view the target virtual object with the display parameters adjusted through the updated three-dimensional image.

As a possible implementation method, the corresponding relationship between the actions (or combinations of actions) on different target parts and the target virtual objects and adjustment methods can be established in advance. Adjustments may include, but are not limited to, adjusting the display parameters of the virtual objects.

When the adjustment operation is based on the image of the target virtual object in the display screen of the first terminal operated by the user, the first terminal may detect the operation position of the user on the display screen and the operation mode, such as pressing, one-finger swiping, two-finger swiping, and the like; determine the target virtual object to be adjusted based on the detected operation position of the user; and then accurately determine the adjusted display parameters based on the operation mode. Similarly, the corresponding relationship between the operation mode and the adjusted display parameters may be configured in the first terminal, and the adjusted display parameters may be obtained by querying the corresponding relationship, thereby updating the three-dimensional image.

FIG. 3B is a flow chart of an image processing method provided in another embodiment of the present disclosure. As shown in FIG. 3B, based on the embodiment shown in FIG. 2, the method, after S204, further includes:
S206: In response to a triggering operation for a target virtual object, displaying association information of the target virtual object.

The target virtual object mentioned in this step is similar to the target virtual object mentioned in step S205, and may be referred to the description in the preceding embodiment.

The association information of the target virtual object may be, but is not limited to, a text, an image, a video, an audio, an animation effects, and the like. For example, the association information is configured to introduce/describe the text, the image, the video, the audio, the animation effect, and the like of the target virtual object.

The first terminal obtains the triggering operation of the target virtual object in a way similar to the way in which the first terminal obtains the adjustment operation of the target virtual object in the embodiment shown in the above-mentioned FIG. 3A. This may refer to the detailed introduction in the embodiment shown in the above-mentioned FIG. 3A, and for sake of brevity, this will not be described again here.

In response to the triggering operation for the target virtual object, the first terminal obtains the association information of the target virtual object, and may further obtain the display parameters of other virtual objects simultaneously. The first terminal superimposes and fuses the image of the real environment that the camera acquires in real time according to the association information of the target virtual object with the display parameters of other virtual objects to generate an updated three-dimensional image, and displays the updated three-dimensional image for the user. The user can watch the association information through the updated three-dimensional image, thereby providing in-depth interaction.

Referring to FIG. 3A and FIG. 3B, the user can enhance the interactivity by interacting with the virtual object in the three-dimensional image, so the above-mentioned methods can meet the interaction needs of the user, thereby improving the user experience.

In addition, in order to help users clearly understand the way to interact with the virtual object in the three-dimensional image, the guidance information may be displayed in the three-dimensional images to guide the user to grasp the way to interact with virtual objects in the three-dimensional image. The present disclosure does not limit the way in which the guidance information may be displayed, and it may also be displayed through a text, an animation, or other ways.

It should also be noted that in the embodiments shown in FIG. 2 to FIG. 3B, in the case that the first terminal is a device for playing a video, the first terminal may further acquire data of the video, fuse the virtual information, an image of the real environment acquired in real time and the data of the video to generate a more interesting three-dimensional image, so that the user may also view the video content more intuitively in the three-dimensional image, thereby providing better content association between the virtual information and the video content and providing better user experience.

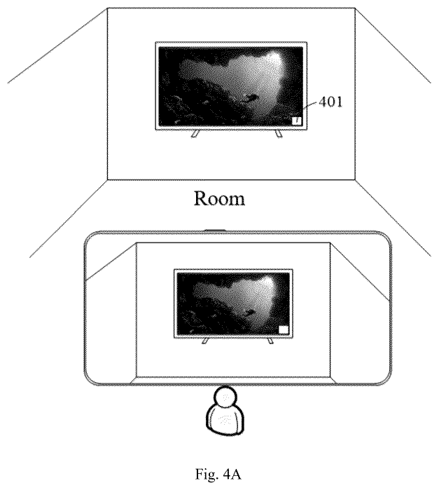

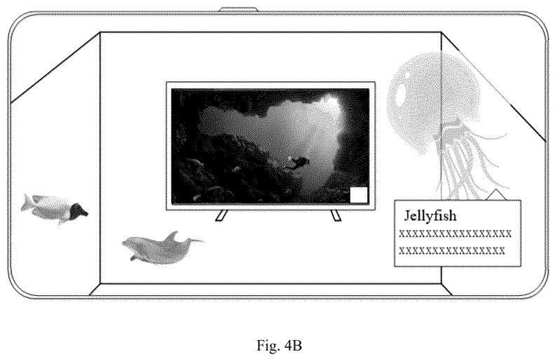

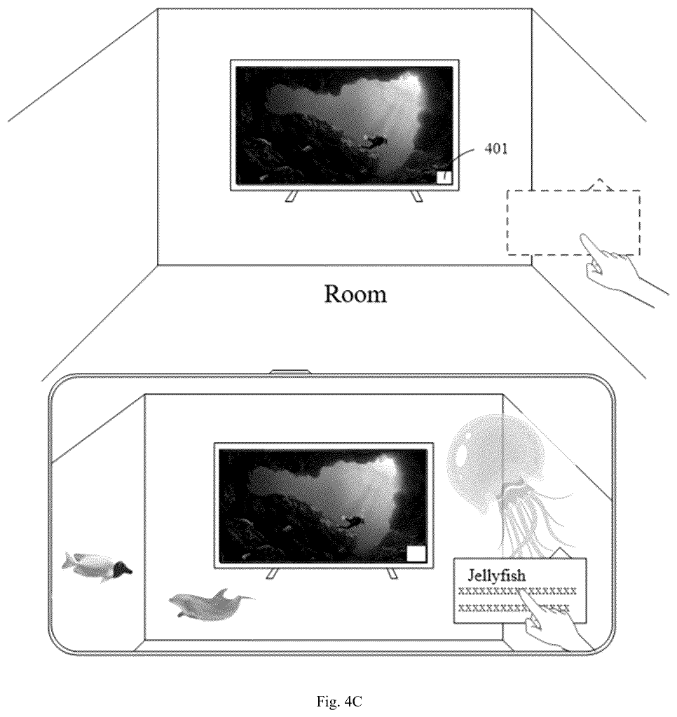

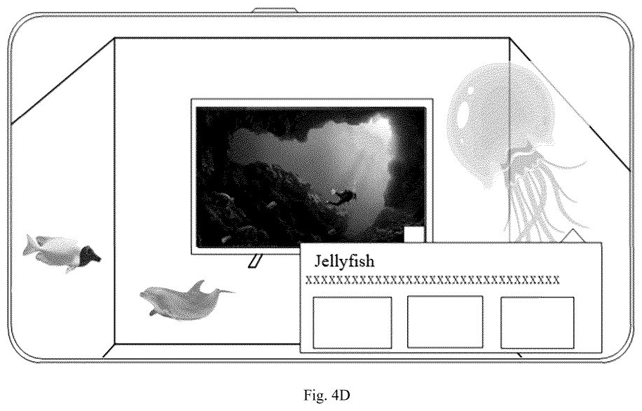

FIG. 4A to FIG. 7C provide schematic diagrams of a scenario and an interactive interface of the first terminal provided in an embodiment of the present disclosure. In the embodiments shown in FIG. 4A to FIG. 7C, it is assumed that the first terminal and the second terminal are in the same room, the first terminal is a smart phone, an AR program is installed in the mobile phone, and the second terminal is a TV fixed on one of the walls of the room.

The AR interaction between the user and the video is illustrated with an example where the TV plays a video 1 on a theme of the ocean, a video 2 on a theme of the universe, a music short video 3, and a video 4 for making a tasty delicacy, and the user scans the QR code patterns in the video pictures of video 1 to video 4 respectively to obtain the corresponding virtual information.
Scenario 1: The TV plays the video 1 on the theme of the ocean.

FIG. 4A is a schematic diagram of a scenario in which the TV on the wall of the room plays the video 1, and the video picture is a picture of the seabed, and there is a QR code pattern 401 of the virtual information corresponding to the current playback position in the lower right corner of the video picture.

It shows a schematic diagram of a scenario in which the user scans the QR code pattern 401 in the video picture shown in FIG. 4A through the rear camera of the mobile phone. By scanning the QR code pattern with the mobile phone, the user can obtain the virtual information corresponding to the current playback position through the way shown in the above-mentioned embodiments. The virtual information includes: the three-dimensional model information of marine creatures, such as jellyfish, and the information of the virtual control corresponding to the jellyfish. After obtaining the virtual information, the mobile phone fuses these marine creatures and virtual controls with the image of the room acquired by the camera of the mobile phone in real time, and display it on the screen of the mobile phone.

Exemplarily, the fused three-dimensional image is shown in FIG. 4B. The user may feel as if these marine creatures are swimming in the room where the user is in through the three-dimensional image displayed by the mobile phone. As shown in FIG. 4B, the three-dimensional image also includes a virtual control corresponding to the jellyfish, and it is assumed that the user can click on the virtual control to trigger the display of multimedia content related to the jellyfish.

As shown in FIG. 4C, the user may hold the mobile phone in the left hand to acquire an image of the room in real time, and move the right hand into a viewing range of the rear camera of the mobile phone to overlap with the position of the virtual control in the three-dimensional image, which represents that the action of the right hand of the user aims at the virtual control. The user may then control the right hand to make a clicking operation, the rear camera of the mobile phone detects the clicking action of the right hand and analyzes the position of the clicking action, determines that the action is used for trigger the virtual control, and then obtains the multimedia content that introduces the jellyfish, and then fuse the multimedia content of the jellyfish with the image of the room acquired by the camera in real time to generate an updated three-dimensional image and display it on the mobile phone screen. The updated three-dimensional image may be exemplarily shown in FIG. 4D.
Scenario 2: The TV plays the video 2 on the theme of the universe.

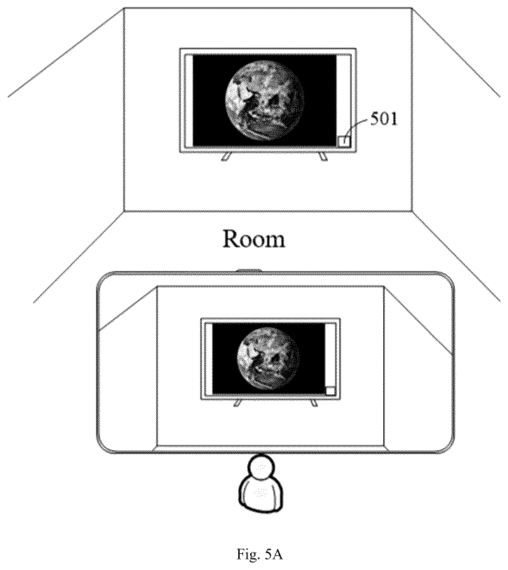

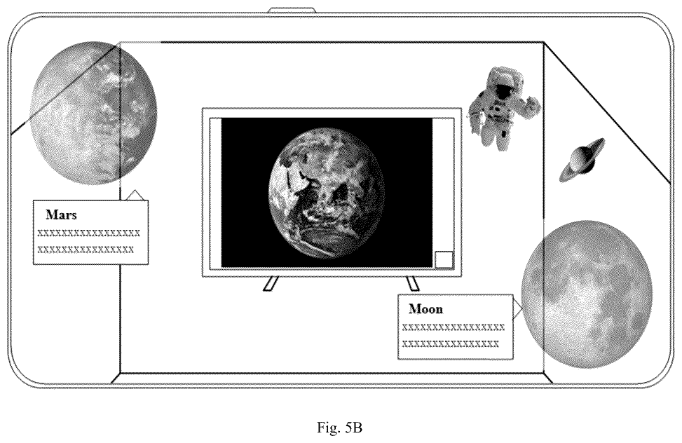

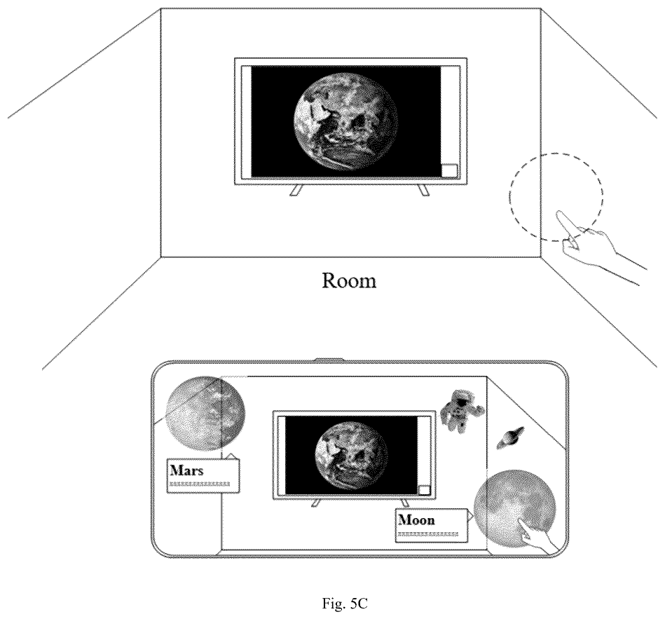

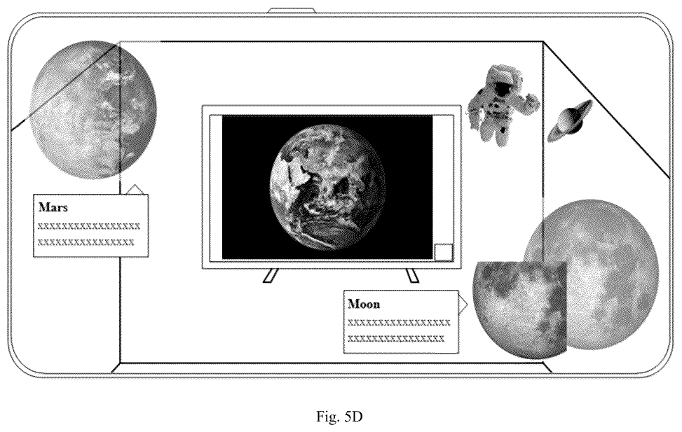

FIG. 5A is a schematic diagram of a scenario in which the TV on the wall of the room plays the video 2, and the video picture is a picture of the universe, and there is a QR code pattern 501 of the virtual information corresponding to the current playback position in the lower right corner of the video picture.

It shows a schematic diagram of a scenario in which the user scans the QR code pattern in the video picture through the rear camera of the mobile phone. By scanning the QR code pattern with the mobile phone, the user can obtain the virtual information corresponding to the current playback position through the way shown in the above-mentioned embodiment. The virtual information includes: the three-dimensional model information of several celestial bodies in the solar system and the information of cards corresponding to celestial bodies, and the cards corresponding to the celestial bodies may be configured to display the introduction information of the celestial bodies. After obtaining the virtual information, the mobile phone fuses the 3D model of the celestial bodies and the cards with the image of the room acquired by the camera of the mobile phone in real time, and display it on the screen of the mobile phone.

Exemplarily, the fused three-dimensional image is shown in FIG. 5B. The user may feel as if these celestial bodies are floating in the room where the user is in through the three-dimensional image displayed by the mobile phone. In addition, the 3D image also includes a card corresponding to a celestial body, which enables the user to understand the relevant information about the celestial body.

Based on the embodiment shown in FIG. 5B, the user may zoom in on a three-dimensional model of a celestial body by a specified action. As shown in FIG. 5C, the user may hold the mobile phone in the left hand to acquire an image of the room in real time, and move the right hand into a viewing range of the rear camera of the mobile phone to overlap with the position of a three-dimensional model corresponding to the moon in the three-dimensional image, which represents that the action of the right hand of the user aims at the moon. The user may then control the right hand to make a specified action (such as double clicking to zoom in on the three-dimensional model of the celestial body), the rear camera of the mobile phone detects the action of the right hand and analyzes the position of the action and determines that the user intends to zoom in on the three-dimensional model of the moon. Therefore, the mobile phone may zoom in on the three-dimensional model of the celestial body and fuses it with the image of the room acquired by the camera in real time to generate an updated three-dimensional image and display it on the mobile phone screen. The updated three-dimensional image may be exemplified as shown in FIG. 5D, and the updated three-dimensional image allows the user to view the details of the surface of the moon to meet the needs of users. In the interface shown in FIG. 5D, some virtual information, such as the cards corresponding to the celestial bodies, some of the celestial bodies, and the like may not be displayed.

Similarly, the user may view the overall structure of the celestial body through a specified action (such as clicking to zoom out on the corresponding three-dimensional model of the celestial body).
Scenario 3: The TV plays a music program (the video 3).

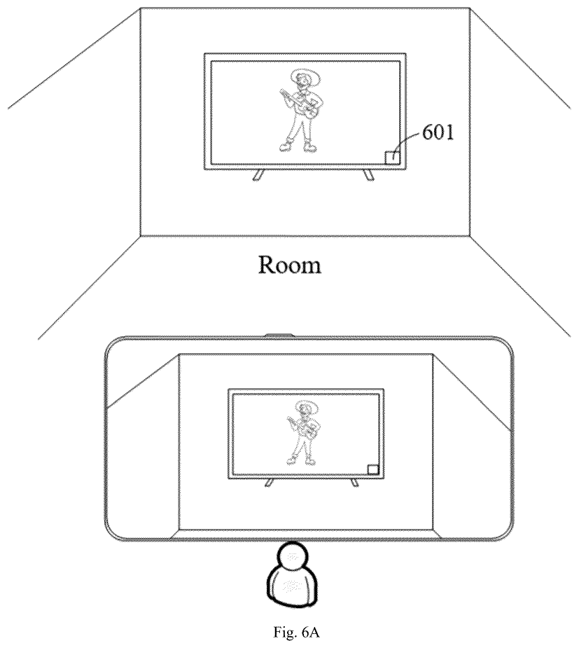

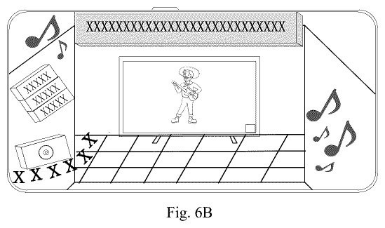

FIG. 6A is a schematic diagram of a scenario in which the TV on the wall of the room plays the music program, and the video frame is a frame in which a singer is singing, and there is a QR code pattern 601 of the virtual information corresponding to the current playback position in the lower right corner of the video frame.

It shows a schematic diagram of a scenario in which the user scans the QR code pattern in the video frame through the rear camera of the mobile phone. By scanning the QR code pattern with the mobile phone, the user can obtain the virtual information corresponding to the current playback position through the way shown in the above-mentioned embodiment. The virtual information includes: information on a 3D bullet screen object contained in the 3D bullet screen music space. After obtaining the virtual information, the mobile phone fuses the 3D bullet screen information with the image of the room acquired by the camera of the mobile phone in real time, and display it on the screen of the mobile phone.

Exemplarily, the fused three-dimensional image is shown in FIG. 6B. The user may feel as if these 3D bullet screen objects are shown in the room where the user is in through the three-dimensional image displayed by the mobile phone. The 3D bullet screen objects include, but are not limited to, a beating musical note shown in FIG. 6B, an element that displays the lyrics in the lower left corner, an element in the upper left corner that displays the bullet screen contents posted by the user, and an element that displays the name of the bullet screen space in the middle. The user may acknowledge the lyrics of the songs sung in the music performance program through the 3D bullet screen objects, view the bullet screen contents published by users who watch the music program, and feel the strong music atmosphere through the beating music notes, thereby bringing a different user experience.

In the scenarios shown in scenarios 1 to 3, the user may input a triggering action or an adjustment action to the mobile phone by operating the mobile phone screen to adjust the target virtual objects such as the jellyfish or the moon.
Scenario 4: The TV plays the video 4 for making a tasty delicacy.

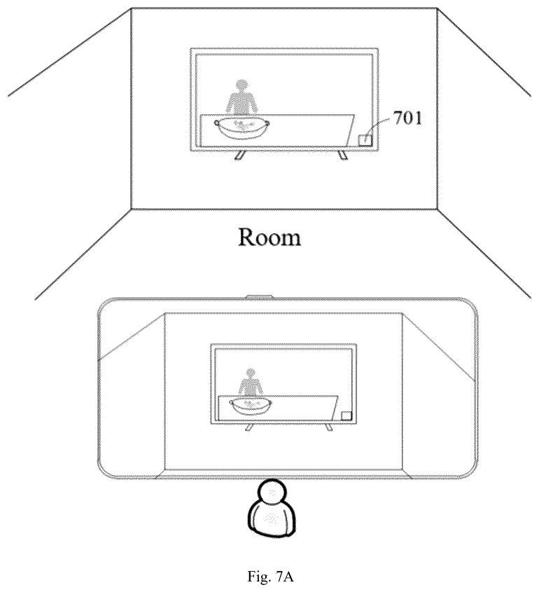

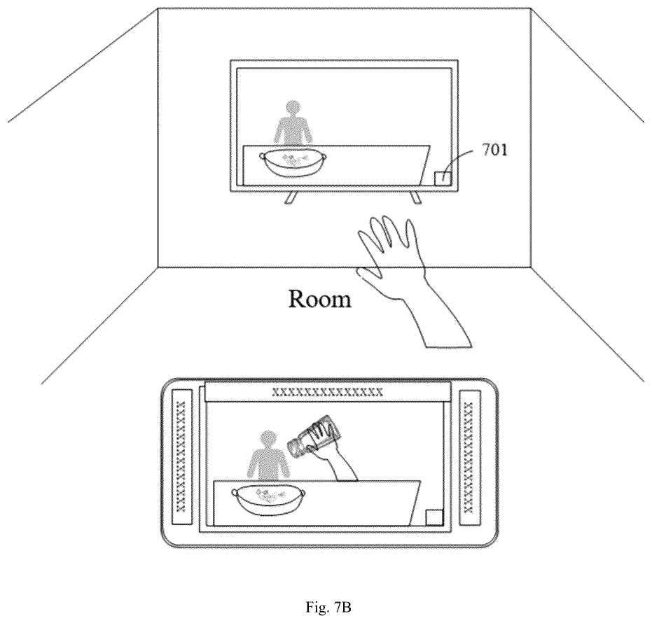

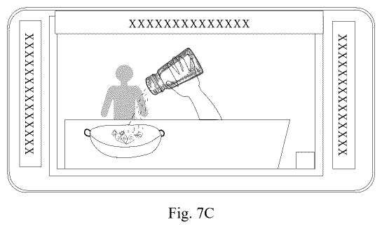

FIG. 7A is a schematic diagram of a scenario in which the TV on the wall of the room plays the video 4, and the video frame is a frame of making a tasty delicacy, and there is a QR code pattern of the virtual information corresponding to the current playback position in the lower right corner of the video frame.

It shows a schematic diagram of a scenario in which the user scans the QR code pattern in the video frame through the rear camera of the mobile phone. By scanning the QR code pattern 701 with the mobile phone, the user can obtain the virtual information corresponding to the current playback position through the way shown in the above mentioned embodiments. The virtual information includes: information on a 3D model of a salt shaker and the bullet screen information posted by users who are watching the video. After obtaining the virtual information, the mobile phone fuses the 3D model of the salt shaker and the bullet screen information with the image of the room acquired by the camera of the mobile phone in real time, and display it on the screen of the mobile phone.

For example, the fused 3D image may be shown in FIG. 7B. The 3D image displayed by the user through a mobile phone may position the salt shaker above a container used to make the dish in the video for making the tasty delicacy (that is, the salt shaker is on top of a pot).

It should be noted that the image of the real environment acquired by the mobile phone may be edited (such as be tailored or scaled, or the like) and fused with the virtual information. For example, in the present embodiment, the image of the room acquired by the camera may be tailored to obtain the video frame part of the second terminal, and scaled to an appropriate proportion, and then the salt shaker and the bullet screen information are fused with the video frame to generate a three-dimensional image and display it. The rectangular boxes on the left, right, and top of the video frame in FIG. 7B are virtual cards that display the bullet screen information.

Based on the embodiments shown in FIG. 7B, the user may control the salt shaker to display a special effect (such as the salt sprinkling effect) by a specified action. As shown in FIG. 7C, the user may hold the mobile phone in the left hand to acquire an image of the room in real time, and move the right hand to a viewing range of the rear camera of the mobile phone to overlap with the position of a three-dimensional model corresponding to the salt shaker, which represents that the action of the right hand of the user aims at the salt shaker. The user may then control the right hand to make a specified action (such as the action of shaking the salt shaker), the rear camera of the mobile phone detects the action of the right hand and analyzes the position of the action to determine that the user intends to sprinkle the salt. Therefore, the mobile phone may acquire the data of the salt sprinkling effect corresponding to the salt shaker and fuse it with the image of the room acquired by the camera in real time to generate an updated three-dimensional image and display it on the mobile phone screen. By using the method of the present embodiment, the user can interact with the video for making a tasty delicacy, as if the user personally participates in the food making process, enhancing the enthusiasm of user interaction and the interactive experience.

In the scenario shown in scenario 4, if the video 4 for making a tasty delicacy is played on a mobile phone, the first terminal can obtain the subsequent video data through identifying the video frame position of the QR code, fuse the video data with the action of a part of body acquired by the camera of the mobile phone and a special effect of sprinkling salt, and display it for the user through the mobile phone.

Using the image processing method provided by the present disclosure in the scenarios exemplified in the scenario 1 to scenario 4 enables the user to interact with the video content displayed in the first terminal/second terminal, bringing a unique sensory experience and improving the interactive effect. In addition, the user can further interact with the virtual object, thereby meeting the interaction needs of the user.

It should be noted that the names of messages or information exchanged between multiple apparatuses in the implementations of the present disclosure are for illustrative purposes only and are not intended to limit the scope of such messages or information.

It should be understood that before using the technical solutions disclosed in the embodiments of this disclosure, the type, scope of use, and use scenarios of the personal information involved in the present disclosure shall be informed to the user and authorization shall be obtained from the user through appropriate methods in accordance with relevant laws and regulations.

For example, in response to receiving an active request from a user, a prompt is sent to the user to explicitly inform the user that acquisition and use of personal information of the user are required to perform the action requested. In this way, the user may choose whether to provide the personal information to software or hardware such as an electronic device, an application, a server, or a storage medium that performs operations of the technical solution of the present disclosure according to the prompt.

As an optional but non-limiting implementation, in response to receiving an active request from a user, a prompt is sent to the user by means such as a pop-up window, where the pop-up window may present the prompt in the form of text. In addition, the pop-up window may also carry a selection control for the user to choose whether to Agree or Disagree to provide the personal information to the electronic device.

It should be understood that the foregoing notification and the process of obtaining user authorization are only illustrative and do not limit the implementations of the present disclosure, and other means that meet the relevant laws and regulations may also be applied in the implementations of the present disclosure.

It should be understood that the data involved in the technical solution of the present disclosure (including but not limited to the data itself, the acquisition or use of data) shall comply with the requirements of relevant laws and regulations and relevant provisions.

Exemplarily, the present disclosure relates to an image processing apparatus.

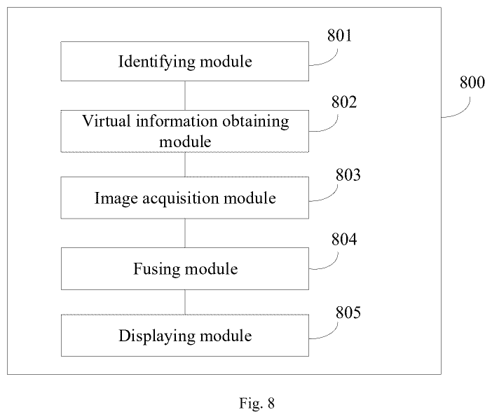

FIG. 8 is a structural schematic diagram of an image processing apparatus provided in an embodiment of the present disclosure. Referring to FIG. 8, the image processing apparatus 800 provided in the present embodiment includes:
an identifying module 801, configured to obtain identification information by identifying an identification pattern in a multimedia image;
a virtual information obtaining module 802, configured to obtain virtual information corresponding to multimedia content displayed in the multimedia image according to the identification information;
an image acquisition module 803, configured to obtain an image acquired in real time;
a fusing module 804, configured to fuse the virtual information with the image acquired in real time to obtain a three-dimensional image.

In some embodiments, the image processing apparatus 800 further includes: a display module 805 configured to display the three-dimensional image.

In some embodiments, the identifying module 801 obtains the identification information corresponding to the multimedia image by identifying a QR code pattern or a barcode pattern in the multimedia image displayed by another terminal.

In some embodiments, the transparency of the identification pattern is lower than a preset threshold.

In some embodiments, the virtual information acquisition module 802 is specifically configured to send the identification information to a service terminal, so that the service terminal determines the virtual information according to the identification information; and receives the virtual information sent by the service terminal.

In some embodiments, the three-dimensional image includes an image of a target virtual object, and the fusing module 804 is further configured to update the three-dimensional image in response to an adjustment operation for the target virtual object.

In some embodiments, the three-dimensional image includes an image of a target virtual object, and the fusing module 804 is further configured to, in response to a triggering operation for the target virtual object, display association information of the target virtual object.

The image processing apparatus provided in the present embodiment may be used to implement the technical solution of any of the method embodiments above, with similar implementation principle and technical effect, which may be referred to the detailed description of the method embodiments above. For the sake of brevity, it will not be described again herein.

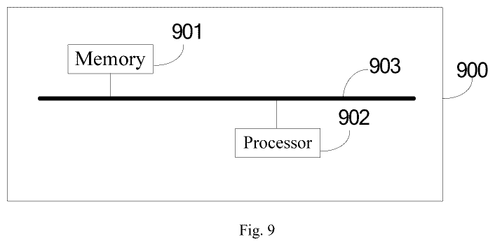

FIG. 9 shows a structurally schematic diagram of an electronic device provided in an embodiment of the present disclosure. Referring to FIG. 9, the electronic device 900 provided in the present embodiment includes: a memory 901 and a processor 902.

The memory 901 may be a separate physical unit and connected with the processor 902 via a bus 903. The memory 901 and the processor 902 may also be integrated together, which may be realized through hardware, etc.

The memory 901 is used to store program instructions, which are called by the processor 902 to execute the image processing method provided by any of the above method embodiments.

Optionally, when some or all of the methods of the above embodiments are implemented through software, the above electronic device 900 may include only the processor 902. The memory 901 for storing the program is located outside of the electronic device 900, and the processor 902 is connected to the memory through circuitry/wires for reading and executing the program stored in the memory.

The processor 902 may be a central processing unit (CPU), a network processor (NP) or a combination of a CPU and an NP.

The processor 902 may further include a hardware chip. The hardware chip may be an application-specific integrated circuit (ASIC), a programmable logic device (PLD) or a combination thereof. The PLD may be a complex programmable logic device (CPLD), a field-programmable logic gate array (FPGA), generic array logic (GAL) or any combination thereof.

The memory 901 may include volatile memory, such as random-access memory (RAM). The memory may also include non-volatile memory, such as flash memory, hard disk drive (HDD) or solid-state drive (SSD). The memory may also include a combination of the above types of memory.

An embodiment of the present disclosure further provides a readable storage medium, which includes: a computer program instruction, when executed by at least one processor of the electric device, the computer program instruction enables the electric device to implement the image processing method provided in the foregoing embodiments.

An embodiment of the present disclosure further provides a computer program product, which, when running on a computer, enables the computer to implement the image processing method provided in the foregoing embodiments.

It should be noted that in the context, the terms such as “first” and “second” are used only to distinguish one entity or operation from another, and do not necessarily require or imply the existence of any actual relationship or order between these entities or operations. Such an actual relationship or order is not necessarily required or implied between the entities or operations. Furthermore, the terms “including”, “comprising”, or any other variant thereof, are intended to cover non-exclusive inclusion, such that a process, method, article, or apparatus comprising a set of elements includes not only those elements, but also other elements not expressly listed, or other elements not expressly listed for the purpose of such a process, method, article, or apparatus. elements, or also includes elements that are inherent to such process, method, article or apparatus. Without further limitation, the fact that an element is qualified by the statement “includes a . . . ” does not preclude the existence of additional identical elements in the process, method, article or apparatus that includes said element.

The foregoing are only specific embodiments of the present disclosure to enable those skilled in the art to understand or realize the present disclosure. Various modifications to these embodiments will be apparent to those skilled in the art, and the general principles defined herein may be realized in other embodiments without departing from the spirit or scope of the present disclosure. Accordingly, the present disclosure will not be limited to these embodiments described herein, but will be subject to the broadest scope consistent with the principles and novel features disclosed herein

1. An image processing method, comprising:
obtaining identification information by identifying an identification pattern in a media image;
obtaining virtual information corresponding to media content displayed in the media image according to the identification information;
obtaining an image acquired in real time; and
obtaining a three-dimensional image based on the virtual information and the image acquired in real time.

2. The method according to claim 1, further comprising: displaying the three-dimensional image.

3. The method according to claim 1, wherein the method is applied to a first terminal, and the obtaining the identification information by identifying the identification pattern in the media image comprises:
obtaining the identification information corresponding to the media image by identifying a QR code pattern or a barcode pattern in the media image displayed by the first terminal to a second terminal.

4. The method according to claim 1, wherein a transparency of the identification pattern is lower than a preset threshold.

5. The method according to claim 1, wherein the obtaining the virtual information corresponding to the media content displayed in the media image according to the identification information comprises:
sending the identification information to a server, so that the server determines the virtual information according to the identification information; and
receiving the virtual information sent by the server.

6. The method according to claim 1, wherein the three-dimensional image comprises a respective image of a target virtual object, and the method further comprises:
in response to an adjustment operation for the target virtual object, updating the three-dimensional image.

7. The method according to claim 1, wherein the three-dimensional image comprises a respective image of a target virtual object, and the method further comprises:
in response to a triggering operation for the target virtual object, displaying association information of the target virtual object.

8. (canceled)

9. An electronic device, comprising: a memory and a processor, wherein,
the memory is configured to store a computer program instruction; and
the processor is configured to execute the computer program instruction to enable the electronic device to implement an image processing method,
wherein the image processing method comprises:
obtaining identification information by identifying an identification pattern in a media image;
obtaining virtual information corresponding to media content displayed in the media image according to the identification information;
obtaining an image acquired in real time; and
obtaining a three-dimensional image based on the virtual information and the image acquired in real time.

10. A readable storage medium, comprising: a computer program instruction, wherein,
the computer program instruction, when executed by an electronic device, enables the electronic device to implement an image processing method,
wherein the image processing method comprises:
obtaining identification information by identifying an identification pattern in a media image;
obtaining virtual information corresponding to media content displayed in the media image according to the identification information;
obtaining an image acquired in real time; and
obtaining a three-dimensional image, based on the virtual information and the image acquired in real time.

11. (canceled)

12. The electronic device according to claim 9, wherein the method further comprising: displaying the three-dimensional image.

13. The electronic device according to claim 9, wherein the method is applied to a first terminal, and the obtaining the identification information by identifying the identification pattern in the media image comprises:
obtaining the identification information corresponding to the media image by identifying a QR code pattern or a barcode pattern in the media image displayed by the first terminal to a second terminal.

14. The electronic device according to claim 9, wherein a transparency of the identification pattern is lower than a preset threshold.

15. The electronic device according to claim 9, wherein the obtaining the virtual information corresponding to the media content displayed in the media image according to the identification information comprises:
sending the identification information to a server, so that the server determines the virtual information according to the identification information; and
receiving the virtual information sent by the server.

16. The electronic device according to claim 9, wherein the three-dimensional image comprises a respective image of a target virtual object, and the method further comprises:
in response to an adjustment operation for the target virtual object, updating the three-dimensional image.

17. The electronic device according to claim 9, wherein the three-dimensional image comprises a respective of a target virtual object, and the method further comprises:
in response to a triggering operation for the target virtual object, displaying association information of the target virtual object.

18. The method according to claim 2, wherein the method is applied to a first terminal, and the obtaining the identification information by identifying the identification pattern in the media image comprises:
obtaining the identification information corresponding to the media image by identifying a QR code pattern or a barcode pattern in the media image displayed by the first terminal to a second terminal.

19. The method according to claim 2, wherein a transparency of the identification pattern is lower than a preset threshold.

20. The method according to claim 2, wherein the obtaining the virtual information corresponding to the media content displayed in the media image according to the identification information comprises:
sending the identification information to a server, so that the server determines the virtual information according to the identification information; and
receiving the virtual information sent by the server.

21. The method according to claim 2, wherein the three-dimensional image comprises a respective image of a target virtual object, and the method further comprises:
in response to an adjustment operation for the target virtual object, updating the three-dimensional image.

22. The method according to claim 2, wherein the three-dimensional image comprises a respective image of a target virtual object, and the method further comprises:
in response to a triggering operation for the target virtual object, displaying association information of the target virtual object.
